(19) United States
(12) Patent Application Publication
(10) Pub. No.: US 2024/0169298 A1
(43) Pub. Date: May 23, 2024

(54) SYSTEM AND METHOD FOR EFFICIENTLY DETERMINING TARGETED TRAINING OBJECTIVES FOR NEW HIRES

(71) Applicant: NICE LTD, Ra'anana (IL)

(72) Inventors: Jordan MAYHUE, Atlanta, GA (US); Eric Richard MICKLEY, Decatur, GA (US); Vincent P. CILANO, Allegany, NY (US); Linh LA, Ajax (CA)

(21) Appl. No.: 18/058,039

(22) Filed: Nov. 22, 2022

(51) Int. Cl. G06Q 10/0639; G06N 3/084; G06Q 50/20

(52) U.S. Cl. CPC G06Q 10/06398; G06N 3/084; G06Q 50/2057

(57) ABSTRACT

The present disclosure provides systems and methods for efficiently determining targeting training objectives for new hires. Employee performance is initially captured to provide a baseline performance, and is utilized, along with targeted performance goals, to determine an expected timeline for when an employee will reach a target performance threshold. This timeline can be used to generate SMART objectives (Specific agent attributes that can be Measured in their growth, which are Attainable and are Resource and Time bound), provide attainable goals and targets for employees, and develop a realistic and concrete training plan to implement.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to methods and systems of determining staff requirements to service contacts arriving in omni channels, which include traditional voice channels as well as digital channels, and more specifically relates to methods and systems of determining staff requirements while accounting for multi-skill and multi-session efficiency.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

A typical call center has an annual attrition rate between 18%-25%. This is especially apparent for new hires, who are significantly more likely to leave within the first three to six months of employment. However, there is a need for a method to ensure an employee's learning curve is acceptable and to use that information to determine development of the employee and to predict areas that may present problems to proactively address. This inability to proactively address problems results in high turnover rates due to lack of training or support where employees need it.

High turnover rates result in increased costs to organizations and their customers, as the investment in recruiting, hiring, performing background checks, and training agents is lost when an individual leaves the company after a short period of employment. The main reason that newly hired agents leave is due to a lack of SMART objectives—Specific agent attributes that can be Measured in their growth, which are Attainable and are Resource and Time bound (SMART).

To solve this issues, targeted coaching is needed to help agents develop in areas of opportunity. By identifying SMART objectives—attainable goals and targets for employees—a concrete training plan can be implemented. The SMART objectives can further be utilized to proactively identify and address problem areas in an employee's development before they lead to the employee leaving the company. Such methods further provide feedback on the training programs implemented by the company. By identifying the effectiveness of types of training for various employees, training methods and individuals conducting training can be improved by identifying effective and ineffective training.

Accordingly, a need exists for improved systems and methods for efficiently determining targeted training objectives for new hires.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is an exemplary diagram of an exemplary flowchart for capturing and utilizing employee performance information according to some embodiments

FIG. 3 is an exemplary diagram of an exemplary flowchart for processing multiple employees' performance information according to some embodiments

FIG. 4 is a simplified diagram of data flow in an exemplary system environment according to some embodiments.

FIG. 5 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

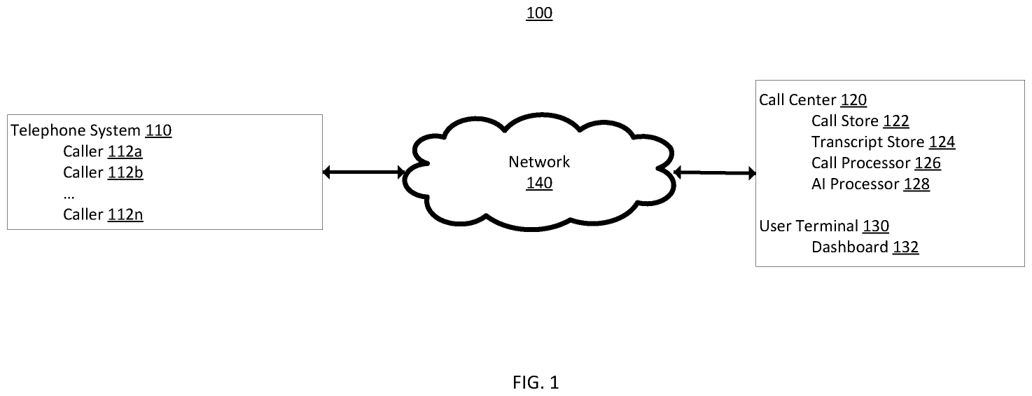

The systems and methods described herein describe systems and methods for efficiently determining targeting training objectives for new hires. FIG. 1 illustrates a block diagram of an example environment 100 according to some embodiments. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML, neural network (NN), and other AI architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities.

FIG. 1 illustrates a block diagram of an example environment 100 according to some embodiments. Environment 100 may include a telephone system 110 and a call center 120 that interact to provide call center services to customers via a network. In other embodiments, environment 100 may not have all the components listed and/or may have other elements instead of, or in addition to, those listed above, or may involve a different service than that of a call center. In some embodiments, the environment 100 is an environment in which employee performance may be evaluated through an ML or other AI system. As illustrated in FIG. 1, call center 120 might interact via a network 140 with callers 112a-112n in telephone system 110, to evaluate employee performance, generate training plans, and provide performance metrics for employees.

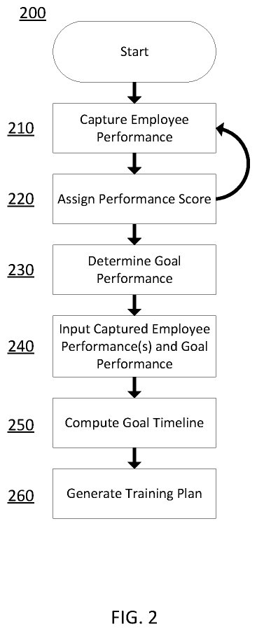

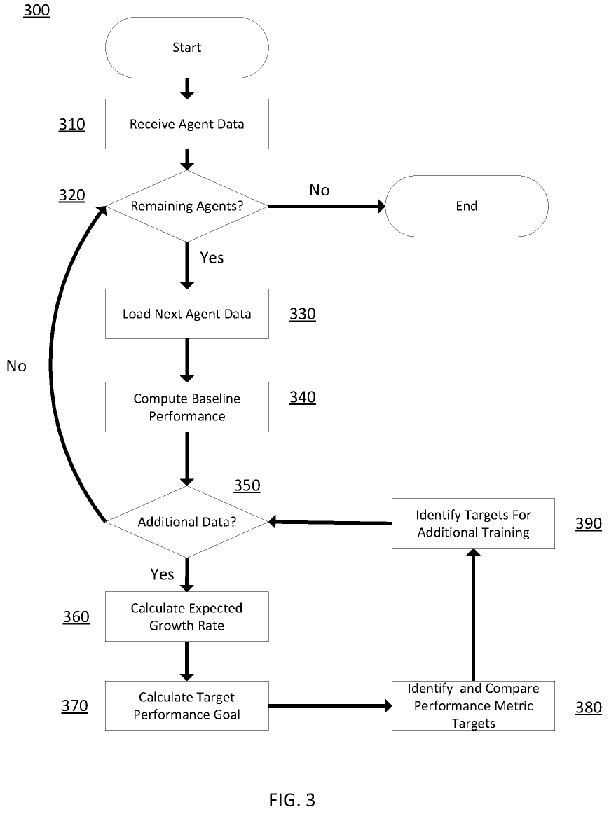

In some embodiments, call center 120 may include a call store 122, transcript store 124, and/or call processor 126. These elements of the call center 120 may individually or collectively store call information and metrics related to individual calls, calls by a specific customer, calls answered by a specific employee, or other information or metrics. Call center 120 may further utilize an AI processor 128 to collect metrics and data, or to utilize call information or metrics collected by one or more of call store 122, transcript store 124, and call processor 126. For instance, AI processor 128 may be in communication with user terminal 130 to directly capture statistics, information, and metrics related to an employee's performance, or alternatively may be in communication with one or more of call store 122, transcript store 124, and call processor 126 to collect statistics, information, and metrics collected regarding an employee. This information may be collected initially to determine baseline performance metrics for the employee, or may be continuously collected during employment to monitor and evaluate employee performance and progression, and to provide a set of goals, targeted training, or information that may be used by a supervisor to evaluate or train an employee, as discussed further below with respect to FIGS. 2-3.

In some embodiments, AI processor 128 may further include a neural network or other machine learning system to receive, process, and learn based on predictive performance. In such embodiments, AI processor 128 may consider the actual performance of an employee as compared to the expected performance, to identify and better tailor AI processor 128 for efficiently determining targeting training objectives for new hires or for generating training plans for employees based on expected employee performance growth.

Several elements in the system shown and described in FIG. 1 include elements that are explained briefly here. For example, the user terminal 130 could include a desktop personal computer, workstation, laptop, notepad computer, PDA, cell phone, or any wireless access protocol (WAP) enabled device or any other computing device capable of interfacing directly or indirectly to the Internet or other network connection. The user terminal 130 may also be a server or other online processing entity that provides functionalities and processing to other user terminals or programs, such that an employee may perform their duties at call center 120 and interact with callers 112a-112n over network 140.

The user terminal 130 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, the client devices and all of its components are configurable using applications, such as a browser, including computer code run using a central processing unit such as an Intel Pentium® processor or the like. However, user terminal 130 may instead correspond to a server configured to communicate with call center 120 or callers 112a-112n, for interaction with the user terminal 130 in order to perform call center duties in a manner which may be monitored by user terminal 130, stored in call store 122 and transcript store 124, processed by call processor 126, and analyzed by AI processor 128. In all embodiments herein, the disclosure may be directed to an analytics center that collects input from and resultant data to a call center.

Thus, call center 120, user terminal 130, and all of their components might be operator configurable using application(s) including computer code to run using a central processing unit, which may include an Intel Pentium® processor or the like, and/or multiple processor units. A server for call center 120 and/or user terminal 130 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring call center 120 and/or user terminal 130 to intercommunicate and to process and collect data related to calls placed with callers 112a-112n over network 140 as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

FIG. 2 shows an exemplary diagram of an exemplary flowchart for capturing and utilizing employee performance information according to some embodiments. In some embodiments, AI processor 128 will perform the steps depicted in FIG. 2. In other embodiments, a suitable computer system or other device will perform the steps.

In step 210, an employee's performance is measured and captured by AI processor 128. For each objective or assignment the employee completes, the AI processor 128 captures the employee's work product or performance. The employee's performance may be directly captured by the AI processor 128 or may be entered into AI processor 128 by a different processor or an individual. The employee's performance may be captured over a set time period. This time period may be measured in hours, days, weeks, or some other length of time, and may be determined by AI processor 128 or a supervisor.

At step 220, a score is assigned to the employee's performance for each captured objective or assignment. In some embodiments, the AI processor 128 assigns a score to the employee's performance for each captured objective or assignment. These scores may be based on (but are not limited to) the employee's performance, the employee's performance on calls, behavior, interactions between the employee and a customer, customer satisfaction, employee written or oral work product, or a combination of such factors. The factors in which the employee's performance is evaluated on may be predetermined or standardized for each employee, in order to compare employees to metrics or each other. The factors may also be predetermined or standardized across a group of employees, for example, to additionally compare an employee across an average for a peer group of employees.

Steps 210-220 may be repeated one or more times over various time periods for the employee. These time periods may be equal in length, or may differ in length. In one embodiment, employee performance is captured for each day. In a different embodiment, employee performance may be captured for one day, then two days, then four days, and so on, doubling the duration of each time period. The start and stop of the time periods may be predetermined, or may be based on the start of employment for the employee.

The initial measurements at the first time period from steps 210-220 provide a baseline score for the employee. This score represents the employee's performance after completing initial onboarding training, for the first time period that they are under evaluation. In some embodiments, during this time period, the employee should receive minimal support to identify baseline employee performance, strengths, and weaknesses, in order to assign a training plan.

Each score assigned to the employee's performance may reflect an average score for each metric, including the employee's performance, the employee's performance on calls, behavior, interactions between the employee and a customer, customer satisfaction, employee written or oral work product, or a combination of such factors, a mean, a median, or some other score attributed to the entire time period in which data was collected for step 210.

Each additional repeat of steps 210-220 may be used to evaluate employee performance progression following the initial measurements. These repeated steps can be compared to the expected performance growth of the employee, to determine whether the employee is on target for their goals, is exceeding expectations, or is not performing as expected. In some embodiments, if an employee is identified as on target for their goals or exceeding expectations, then AI processor 128 may not evaluate the employee further or provide an updated goal or training plan for the employee.

At step 230, the AI processor 128 determines a goal performance for one or more factors related to employee performance. These factors may be predetermined, or may be factors that are identified by AI processor 128. The goal performance may be related to number of calls over a period of time, customer satisfaction, or other measurable attribute of the employee. In other embodiments, the goal performance may be related to the employee's behavior, interactions between the employee and a customer, and/or written or oral skills. These goals may be consistent between employees, or may vary based on attributes specific to each employee, a group of employees, or some other identified reason.

At steps 240-250, timelines for achieving goals are computed for the employee based on the captured performances based on the employee performance(s) and goal performances for one or more factors. In some embodiments, employee performance(s) and goal performances are input into AI processor 128. In other embodiments, employee performance(s) and goal performances that have previously been collected and determined by AI processor 128 are utilized. For each factor, AI processor 128 utilizes the baseline employee performance captured in the first time period for steps 210-220 to determine a baseline score for the employee. AI processor 128 determines, using this baseline score, an expected timeline for improvement of the employee's performance, including a specific time of when the employee is expected to reach the goal performance for the factor. This timeline for improvement may be a set amount of time (e.g., the number of hours, days, weeks, or months that it will take for the employee to reach the goal performance) or may be a specific date or time.

At step 260, a training plan is generated for the employee. In one embodiment, AI processor 128 flags various employee attributes based on the computed goal timelines. The employee's attributes may be flagged to identify areas of potential weakness or concern, areas of potential strength, areas requiring additional training or attention, or other areas of interest. AI processor may also generate a report for review identifying the flags or other characteristics or information determined to be of interest for the employer.

In another embodiment, AI processor 128 may provide a training plan for the employee based on the computed goals. For instance, AI processor 128 may determine that the captured employee performance and goal performance resembles a previous employee assigned a training plan, and assign the same training plan to the employee. AI processor 128 may alternatively identify training elements to assign to the employee based on the computed goals. For employees identified as not performing as expected in steps 210-220, AI processor 128 may further flag or identify areas for review or additional training.

FIG. 3 shows an exemplary diagram of an exemplary flowchart for processing multiple employees' performance information according to some embodiments. In some embodiments, AI processor 128 will perform the steps depicted in FIG. 3. In other embodiments, a suitable computer system or other device will perform the steps.

At step 310, AI processor 128 receives agent data for one or more agents who are being evaluated. This agent data includes collected data on the agent performance, goals for each agent, and any other relevant information or data. At step 320, AI processor determines whether it has processed the received agent data for all agents included, and if so, ends its processing of such agent data.

At step 330, AI processor 128 loads the data for the next agent to be processed. This agent data includes collected data on agent performance, goals for the agent, and any other relevant information or data. This data could be data captured by AI processor 128. Specifically, an agent's performance is measured and captured by AI processor 128. For each objective or assignment the agent completes, the AI processor 128 captures the agent's applicable work product or performance. The agent's performance may be directly captured by the AI processor 128 or may be entered into AI processor 128 by a different processor or an individual, such as a supervisor. The agent's performance may be captured over a set time period. This time period may be measured in hours, days, weeks, or some other length of time, and may be determined by AI processor 128 or a supervisor. The factors in which the agent's performance is evaluated on may be predetermined or standardized for each agent, in order to compare agents to metrics or each other, to compare over different time periods for the same agent, additionally compared against a peer group of agents, or a combination thereof. In some embodiments, goals are provided for each agent to AI processor 128. In other embodiments, the AI processor 128 determines a goal performance for one or more factors related to agent performance. These factors may be predetermined, or may be factors that are identified by AI processor 128. The goal performance may be related to number of calls over a period of time, customer satisfaction, or other measurable attribute of the agent. In other embodiments, the goal performance may be related to the agent's behavior, interactions between the agent and a customer, and/or written or oral skills. These goals may be consistent between agents, or may vary based on attributes specific to each agent, a group of agents (e.g., performing a particular function, or serving in a call center focused on a particular product or service), or some other identified reason. In some embodiments, step 330 is performed in real-time as agent data is aggregated and collected for an agent. It should be understood that real-time may be deferred for about up to about 5, about 10, or about 20 seconds given the need to transmit and process substantial quantities of data according to the disclosure herein. In other embodiments, step 330 is performed for data that has been previously collected and stored in a database.

At step 340, AI processor 128 computes the baseline performance for the agent. A score is then assigned to the agent's performance for each captured objective or assignment. In some embodiments, the AI processor 128 assigns a score to the agent's performance for each captured objective or assignment. These scores may be based on (but are not limited to) the agent's performance, the agent's performance on calls, behavior, interactions between the agent and a customer, customer satisfaction, agent written or oral work product, or a combination of such factors. In other embodiments, this baseline performance is included in the agent data provided to AI processor 128 at step 330. In such embodiments, the baseline performance may be calculated by AI processor 128 at an earlier time, such as during a previous iteration of the steps discussed for FIG. 3, in order to reduce the required computing and retain data and calculations previously performed for analyzing agent performance. Alternatively, the baseline performance may be calculated by a separate computer or processor dedicated to assigning scores to metrics recorded for agents, a part of the agent's system or other software the agent interacts with, a supervisor, or any other method in which values may be assigned to the agent's performance. This baseline performance represents the agent's initial performance as measured as an average of the agent's performance following initial onboarding or other training. The baseline performance may be calculated as the median score for a metric over the period of time in which the agent is being evaluated, a mean score, a max score, a minimum score, or some other calculated score using one or more of each instance of a metric recorded and assigned a value over the period of time in which the agent is being evaluated.

At step 350, after calculating the baseline performance for the agent, AI processor 128 determines whether there is additional data for that time period or for an additional time period, or both. If not, AI processor 128 repeats steps 320-340 for any remaining agents in the agent data. If additional data is available, AI processor 128 proceeds to step 360. In some embodiments, AI processor 128 may not proceed to step 360 despite having additional data, such as if the additional data is captured over a time period that is too short, a supervisor is interested in seeing metrics regarding a specific time period for the agent, or any other reason determined by AI processor 128, a supervisor, or any other authorized user of the system and methods.

At step 360, AI processor 128 calculates the expected growth rate for the agent. This growth rate represents the initial learning rate for a metric for the agent. The growth rate is used to calculate when the agent is expected to become proficient at a skill related to the metric, based on their baseline performance and a pre-set threshold that is considered sufficiently proficient. The growth rate shows the rate at which an agent is expected to improve at measured metrics over time, given the baseline performance data collected for the agent. Accordingly, it may be desirable to collect baseline data with minimal training or intervention for the agent, to accurately gauge the agent's initial skill and competency without training. Thus, the growth rate, and calculations made with the growth rate, may better capture improvement in an agent's performance over time and provide a better metric for identifying additional training or goals appropriate for an agent.

At step 370, using the growth rate calculated at step 360, AI processor 128 calculates the target performance goal timeline to determine how long the agent should take to reach the target goal included in the agent data. This calculation may include the predicted them in which the agent is expected to become proficient, the expected time period in which the agent is expected to become proficient, or some other measurement of when the agent is expected to become proficient.

At step 380, using the growth rate calculated at step 360 and the performance data collected for the agent, AI processor 128 identifies and compares the performance of the agent to the target metrics set out for the agent. For instance, using the calculated growth rate, AI processor 128 may determine what proficiency scores are expected for the agent at the time period for which the AI processor 128 is evaluating the agent. AI processor 128 can identify whether the agent is on track to be at their expected proficiency level on or before the date determined in step 370, and whether they are at their expected proficiency level for the time of the evaluation.

At step 390, AI processor 128 utilizes the calculated performances from step 380 to identify and flag potential metrics for which the agent may be below proficiency or off track to be at their expected proficient level on or before the date determined in step 370. This information may be used to identify agents requiring more training or a modified training plan. In some embodiments, AI processor 128 utilizes the information gathered in steps 360-390 to suggest additional training or changes to the training plan for the agent, or otherwise modifies the training plan for the agent. The suggested training may be oriented towards a single metric or specific metrics recorded and analyzed for the agent, or may be oriented towards the overall performance or a collection of metrics, based on metrics identified by AI processor 128, previous employee performance, employee deviation from goals, or other elements considered by AI processor 128. Additionally, goals may be identified for the agent based on the updated or modified training plan, changes in employee growth rate or performance, or any other observations made by AI processor 128, a supervisor, or any other party.

AI processor 128 may repeat steps 360-390 for additional time periods for the agent if data is available for them, to determine how the agent has progressed over each time period in which data was collected, identify plateaus in the agent's progress, and identify other patterns for metrics measured for the agent. Each time period may be of the same length, or of different lengths. In one embodiment, the time periods may increasingly double, such that each subsequent time period is twice as long as the previous time period. After AI processor 128 has analyzed all of the data for the agent, AI processor 128 returns to step 320 and repeats the calculations and analysis for remaining agents as needed.

In some embodiments, the processing described in FIG. 3 may instead be used to identify training plan effectiveness or to evaluate individual training agents. For instance, the agent data in step 310 may include that only for agents who have received specific types of training plans or agents who have been trained by a specific individual. In this way, AI processor 128 can determine the effectiveness of the training for the agents and help identify patterns in the metrics. AI processor 128 may flag metrics that are collectively below average or above average to indicate training methods or individuals who are unsuccessful to change the training, or to identify training methods or individuals who are succeeding (or improving more quickly) to identify successful training behaviors or potential trainers.

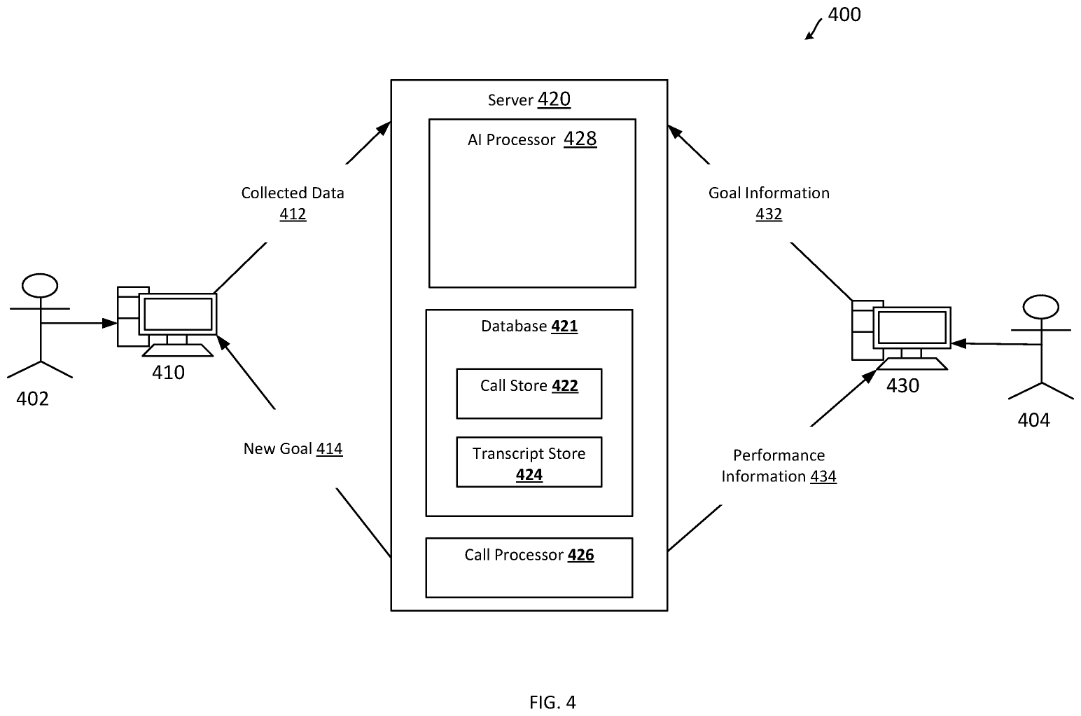

FIG. 4 is a simplified diagram of data flow in an exemplary system environment according to some embodiments. Environment 400 of FIG. 4 includes one or more of agent 402, supervisor 404, agent client 410, supervisor client 430, server 420, and AI processor 428. AI processor 428 may correspond to AI processor 128 as discussed in reference to FIG. 1. Server 420 may further include a database 421 that stores call information in call store 422 and/or transcript store 424. In some embodiments, server 420 may further include call processor 426 to evaluate and score an agent's calls and provide metrics based on the collected data from agent client 410, or the functionality of call processor 426 may be implemented in AI processor 428.

In environment 400, agent 402 interacts with agent client 410 when performing job duties. For instance, if agent 402 works in a call center, agent 402 may utilize agent client 410 to perform call center duties, place calls, or otherwise perform duties related to their employment. Agent client 410 may include user terminal 130 and dashboard 132 as discussed in reference to FIG. 1. Agent client 410 may capture information and statistics related to agent 402, including metrics such as the agent's performance, the agent's performance on calls, the duration of the agent's calls, behavior, interactions between the agent and a customer, customer satisfaction, agent written or oral work product, a combination of such factors, or any other relevant information or statistics related to agent 402. Agent client 410 may send the collected data 412 to the server 420, where it is processed by AI processor 428.

Supervisor 404 interacts with supervisor client 430 to provide information such as predetermined goals 432 for the agent 402 to server 420. This goal information may be utilized by AI processor 428 when developing training plans for new agents, determining whether agents are performing as expected when checking agent progress, or provide other important input or contextual information for AI processor 428. Supervisor client 430 may receive information from AI processor 428 and allow supervisor 404 to interact with provided information, graphically display information related to the performance of agent 402, or otherwise allow supervisor 404 to perform their duties.

In one embodiment, server 420 may store data provided by agent client 410 and supervisor 430 in database 421. Call data may be stored in call store 422, while transcript data may be stored in 424. Call processor 426 may communicate with database 421 to analyze data stored in database 421, including call information stored in call store 422 and/or transcript store 424. Call processor may analyze the data collected regarding agent 402 and assign numeric score values to the agent 402 performance for one or more metrics collected by agent terminal 410. For instance, call processor 426 may analyze and provide numeric scores to each of the calls stored in call store 422 for agent 402, such as a score for duration of call, a score for customer satisfaction, and/or a score for any other metric collected and stored in call store 422. Similarly, call processor 426 may analyze and provide numeric scores to each of the transcripts stored in transcript store 424, including a score for the length of the transcript, a score for the words used by the customer or agent 402 in the transcript, a score for tone of the transcript, or a score for any other metric collected and stored in transcript store 424.

In another embodiment, AI processor 428 generates various information, goals, and training plans based on collected data 412 received from agent client 410, predetermined goals 432 from supervisor client 430, and other collected information by server 420. AI processor 428 may perform the steps of FIGS. 2-3. For instance, AI processor 428 may capture employee performance using collected data 412 provided by agent client 410. AI processor 428 provides performance scores to one or more of the metrics included in collected data 412, including call duration, behavior, interactions between the agent and a customer, customer satisfaction, agent written or oral work product, or other metrics measured or collected for agent 402. AI processor 428 determines goal performances for agent 402 based on the collected data 412, predetermined goals 432, and/or any other information provided by agent 402 or supervisor 404. In some embodiments, AI processor 428 independently determines goal performances for agent 402 without input from supervisor 404. Using this information, AI processor 428 computes goals, goal timelines, suggested training plans, and any other information relevant to the development of agent 402. This information is then provided to agent 402, supervisor 404, and/or any other relevant parties.

Server 420, using information generated by AI processor 428, provides performance information 434 to supervisor 404. This performance information 434 may include information captured by agent client 410, including collected data 412. Performance information 434 may further include identified metrics where agent 402 is underperforming compared to expectations, metrics where agent 402 is overperforming compared to expectations, or information on any or all metrics in which AI processor 428 is evaluating agent 402. Performance information 434 may further include a report flagging areas of concern for agent 402, areas where agent 402 is underperforming compared to a current training plan, or other information that may be useful for supervisor 404 in performing supervisory duties. Additionally, AI processor 428 may provide information to supervisor 404 including proposed training plans, proposed goals, or other useful information for training agent 402. AI processor 428 may further provide information regarding the performance of one or more agents 402 who work under supervisor 404, to provide information regarding the performance of training performed by supervisor 404 or other information related to the performance of supervisor 404.

Server 420, using AI processor 428, also provides new goals 414, training plans, or other information to agent 402. The new goals 414 may include an initial goal or training plan for a new agent, or an updated goal or training plan for an agent based on performance progress since beginning employment, current performance, and expected performance, for one or more metrics measured and provided to AI processor 428. These new goals 414 may be provided in various modalities, including displayed, printed, updated in a portal for later review, emailed, or any combination thereof. Alternatively, these new goals 414, training plans, and/or other information may be provided to supervisor 404 for review, modification, or assignment to agent 402. These new goals 414 may be displayed, printed, updated in a portal for later review, emailed, or any combination thereof.

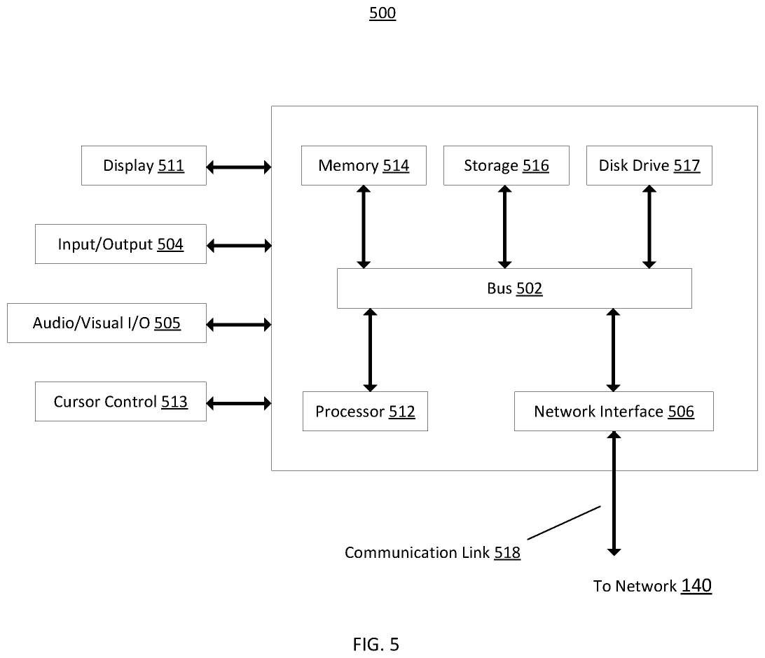

FIG. 5 is a block diagram of a computer system suitable for implementing one or more components in FIG. 1, according to an embodiment. In various embodiments, the communication device may include a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers, such as user terminal 130, may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). Display 511 and cursor control 513 may operate to allow users to interact with dashboard 132. An optional audio/visual input/output component 505 may also be included to allow a user to use voice for inputting information by converting audio signals. Audio/visual I/O component 505 may allow the user to hear audio, and well as input and/or output video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that include bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A method of determining personalized goals for staff performance, which comprises:
capturing, over a first time period, a first time period performance of an employee;
assigning a first score to the first time period performance;
capturing, over a second time period, a second time period performance of the employee;
assigning a second score to the second time period performance;
receiving a target employee performance threshold;
inputting, into a performance model, the first score, the second score, and the target employee performance threshold;
computing, using the performance model, a target performance goal for the employee based on one or more of the first score, the second score, and the target employee performance threshold, wherein the target performance goal comprises a time of when the employee will reach the target employee performance threshold; and
generating, using the performance model, a training plan for the employee using the target performance goal.

2. The method of claim 1, which further comprises:
capturing, over a third time period, a third time period performance of the employee;
assigning a third score to the third time period performance;
inputting, into the performance model, the third time period performance and the third score;
computing, using the performance model, an expected score of the employee at an end time of the third time period based on the first score and second score;
computing, using the performance model, a degree of variance of the third time period performance of the employee based on the third score and the expected score; and
modifying, using the performance model, the training plan for the employee based on the degree of variance and the time associated with the target performance goal.

3. The method of claim 2, which further comprises:
computing, using the performance model, at least one additional degree of variance of at least one additional time period performance for at least one additional employee;
computing, using the performance model, a performance score of the training plan based on the degree of variance of the third time period performance of the employee and the at least one additional degree of variance of the at least one additional time period performance for at least one additional employee to calculate the effectiveness of the training plan; and
modifying, using the performance model, the training plan based on the calculated effectiveness of the training plan.

4. The method of claim 1, wherein each subsequent time period is twice as long as a preceding time period of at least the first time period and the second time period.

5. The method of claim 1, wherein the performance model includes a neural network, wherein the neural network:
receives, as input, the first score, the second score, the target employee performance threshold, and the target performance goal; and
generates, as output, the training plan for the employee.

6. The method of claim 5, which further comprises:
capturing, over a third time period, a third time period performance of an employee;
assigning a third score to the third time period performance; and
inputting, into the performance model, the third time period performance and the third score;
computing, using the neural network, an expected score of the employee at an end time of the third time period based on the first score and second score;
computing, using the neural network, a degree of variance of the third time period performance of the employee based on the third score and the expected score; and
updating, through backpropagation, the neural network based on the degree of variance.

7. The method of claim 5, which further comprises:
receiving, as input, the performance at the time associated with the target performance goal of the employee;
assigning an outcome score to the performance at the time associated with the target performance goal;
computing, using the neural network, a degree of variance of the third time period performance of the employee based on the performance at the time associated with the target performance goal and the target performance goal; and
updating, through backpropagation, the neural network based on the degree of variance.

8. A system of determining personalized goals for staff performance, which comprises:
a processor and computer readable medium operably coupled thereto, the computer readable medium comprising a plurality of instructions stored in association therewith that are accessible to, and executable by, the processor, to generate personalized goals for staff performance by:
capturing, over a first time period, a first time period performance of an employee;
assigning a first score to the first time period performance;
capturing, over a second time period, a second time period performance of the employee;
assigning a second score to the second time period performance;
receiving a target employee performance threshold;
inputting, into a performance model, the first score, the second score, and the target employee performance threshold;
computing, using the performance model, a target performance goal for the employee based on one or more of the first score, the second score, and the target employee performance threshold, wherein the target performance goal comprises a time of when the employee will reach the target employee performance threshold; and
generating, using the performance model, a training plan for the employee using the target performance goal.

9. The system of claim 8, which further comprises:
capturing, over a third time period, a third time period performance of the employee;
assigning a third score to the third time period performance; and
inputting, into the performance model, the third time period performance and the third score;
computing, using the performance model, an expected score of the employee at an end time of the third time period based on the first score and second score;
computing, using the performance model, a degree of variance of the third time period performance of the employee based on the third score and the expected score; and
modifying, using the performance model, the training plan for the employee based on the degree of variance and the time associated with the target performance goal.

10. The system of claim 9, which further comprises:
computing, using the performance model, at least one additional degree of variance of at least one additional time period performance for at least one additional employee;
computing, using the performance model, a performance score of the training plan based on the degree of variance of the third time period performance of the employee and the at least one additional degree of variance of the at least one additional time period performance for at least one additional employee to calculate the effectiveness of the training plan; and
modifying, using the performance model, the training plan based on the calculated effectiveness of the training plan.

11. The system of claim 8, wherein each subsequent time period is twice as long as a preceding time period of at least the first time period and the second time period.

12. The system of claim 8, wherein the performance model includes a neural network, wherein the neural network:
receives, as input, the first score, the second score, the target employee performance threshold, and the target performance goal; and
generates, as output, the training plan for the employee.

13. The system of claim 12, which further comprises:
capturing, over a third time period, a third time period performance of an employee;
assigning a third score to the third time period performance;
inputting, into the performance model, the third time period performance and the third score;
computing, using the neural network, an expected score of the employee at an end time of the third time period based on the first score and second score;
computing, using the neural network, a degree of variance of the third time period performance of the employee based on the third score and the expected score; and
updating, through backpropagation, the neural network based on the degree of variance.

14. The system of claim 12, which further comprises:
receiving, as input, the performance at the time associated with the target performance goal of the employee;
assigning an outcome score to the performance at the time associated with the target performance goal;
computing, using the neural network, a degree of variance of the third time period performance of the employee based on the performance at the time associated with the target performance goal and the target performance goal; and
updating, through backpropagation, the neural network based on the degree of variance.

15. A non-transitory computer-readable medium having stored thereon computer-readable instructions executable to determine personalized goals for staff performance, in which the computer-readable instructions to determine personalized goals for staff performance comprises:
capturing, over a first time period, a first time period performance of an employee;
assigning a first score to the first time period performance;
capturing, over a second time period, a second time period performance of the employee;
assigning a second score to the second time period performance;
receiving a target employee performance threshold;
inputting, into a performance model, the first score, the second score, and the target employee performance threshold;
computing, using the performance model, a target performance goal for the employee based on one or more of the first score, the second score, and the target employee performance threshold, wherein the target performance goal comprises a time of when the employee will reach the target employee performance threshold; and
generating, using the performance model, a training plan for the employee using the target performance goal.

16. The non-transitory computer-readable medium of claim 15, which further comprises:
capturing, over a third time period, a third time period performance of the employee;
assigning a third score to the third time period performance;
inputting, into the performance model, the third time period performance and the third score;
computing, using the performance model, an expected score of the employee at an end time of the third time period based on the first score and second score;
computing, using the performance model, a degree of variance of the third time period performance of the employee based on the third score and the expected score; and
modifying, using the performance model, the training plan for the employee based on the degree of variance and the time associated with the target performance goal.

17. The non-transitory computer-readable medium of claim 16, which further comprises:
computing, using the performance model, at least one additional degree of variance of at least one additional time period performance for at least one additional employee; and
computing, using the performance model, a performance score of the training plan based on the degree of variance of the third time period performance of the employee and the at least one additional degree of variance of the at least one additional time period performance for at least one additional employee to calculate the effectiveness of the training plan; and
modifying, using the performance model, the training plan based on the calculated effectiveness of the training plan.

18. The non-transitory computer-readable medium of claim 15, wherein each subsequent time period is twice as long as a preceding time period of at least the first time period and the second time period.

19. The non-transitory computer-readable medium of claim 15, wherein the performance model includes a neural network, wherein the neural network:
receives, as input, the first score, the second score, the target employee performance threshold, and the target performance goal; and
generates, as output, the training plan for the employee.

20. The non-transitory computer-readable medium of claim 19, which further comprises:
capturing, over a third time period, a third time period performance of an employee;
assigning a third score to the third time period performance;
inputting, into the performance model, the third time period performance and the third score;
computing, using the neural network, an expected score of the employee at an end time of the third time period based on the first score and second score;
computing, using the neural network, a degree of variance of the third time period performance of the employee based on the third score and the expected score; and
updating, through backpropagation, the neural network based on the degree of variance.
